(19) United States
(12) Patent Application Publication
(10) Pub. No.: US 2009/0014441 A1
(43) Pub. Date: Jan. 15, 2009

(54) Microwave plasma cooking

(76) Inventors: Dominique Tasch, Mietingen (DE); David Brosky, Macomb, MI (US); Stephen Conrad, Canton, MI (US); Satyendra Kumar, Troy, MI (US); Devendra Kumar, Rochester Hills, MI (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/455,268

(22) Filed: Jun. 16, 2006

Related U.S. Application Data
(60) Provisional application No. 60/691,392, filed on Jun. 17, 2005.

(51) Int. Cl. H05B 6/64

(52) U.S. Cl. 219/679; 219/680; 426/243; 426/523

(57) ABSTRACT

A method of cooking a food item is disclosed. The food item is placed in a microwave cavity and exposed to a microwave generated plasma. In such fashion, the food item is cooked very quickly while maintaining flavor, texture, appearance, smell, and taste.

### RELATED APPLICATIONS

This application claims the benefit of Provisional Application No. 60/691,392, filed Jun. 17, 2005, which is hereby incorporated by reference in its entirety.

### BACKGROUND

1. Field of the Invention

The present invention is related to an apparatus for cooking food and, in particular, to an apparatus that utilizes a microwave generated plasma in the cooking of food.

2. Discussion of Related Art

Techniques for the fast preparation of food are in demand for both the fast-food industries and the prepared foods industries. In both cases, increased speed in cooking while maintaining or creating flavor, texture, smell, and appearance are important factors.

Therefore, there is further need for apparatus and techniques for fast cooking of foods with appropriate flavor, texture, smell, and appearance.

### SUMMARY

In accordance with the present invention, a method of cooking food utilizing a microwave produced plasma is presented. In some embodiments of the invention, a food item is placed in a cavity where a plasma is ignited. In some embodiments, gas such as Argon or Nitrogen, for example, can be flowed through the cavity to produce the plasma and to displace oxygen from the cooking area. In some embodiments, flavor agents can be introduced to the gas flow.

Exposing the food item to the ignited plasma can very quickly cook the food item as well as to brown the food item to a pleasant coloring and texture. Further, textures that are currently unavailable by other techniques (such as a hamburger that is rare on the inside but crispy on the outside) can be created.

A cooking apparatus according to the present invention includes a microwave cavity, the microwave cavity including a support on which a food item is placed; and a microwave source coupled to the microwave cavity, wherein a microwave plasma is generated in the microwave cavity to cook the food item placed on the support.

A method of cooking a food item according to the present invention includes placing the food item on a support mounted in a microwave cavity; placing a plasma catalyst in the microwave cavity; flowing gas through the microwave cavity; applying microwave power to the microwave cavity to ignite a plasma; cooking the food item with the plasma; and removing the cooked food item from the microwave cavity.

Several embodiments of the invention are further discussed below with reference to the following figures.

### BRIEF DESCRIPTION OF THE DRAWINGS

FIG. 1 illustrates an example microwave chamber for the cooking of food items.

FIG. 2 illustrates a cavity in the microwave chamber for cooking food items using a plasma immersion method.

FIG. 3 illustrates a cavity in the microwave chamber for cooking food items using a plasma jet method.

### DETAILED DESCRIPTION

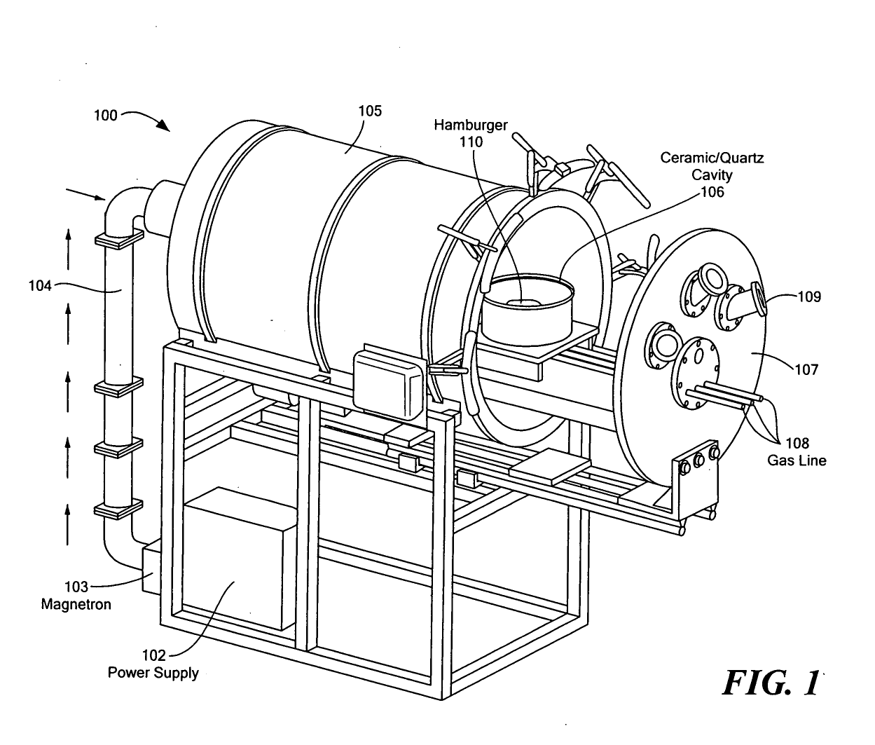

FIG. 1 illustrates a cooking chamber (or oven) for cooking food items with a microwave plasma according to some embodiments of the present invention. As shown in FIG. 1, cooking chamber 100 includes a cavity 106 in which a food item 110 is placed and a chamber 105. Cavity 106 can be placed into chamber 105 and secured in place. Microwave energy is introduced into chamber 105 through waveguide 104 by magnetron 103. Magnetron 103 is powered by power supply 102. As shown FIG. 1, chamber 105 can be sealed by cover 107. Gas lines 108 and exhaust ports 109 can be coupled into cooking chamber 100.

In practice, food item 110 can be placed in cavity 106 and the combination sealed into chamber 105 with cover 107. Microwaves introduced through waveguide 104 can be utilized both to cook food item 110 and to generate a plasma in cavity 106 to cook food item 110. Generation of a microwave plasma is further explained in U.S. application Ser. No. 10/430,426, “Plasma Catalyst,” by Satyendra Kumar et al., filed on May 7, 2003, herein incorporated by reference in its entirety. Alternatively, plasma can be created by any one of the several other ways such as, e.g., sufficiently high microwave energy (CW or pulsed), resonant field enhancement (as in a single mode resonator), placing a sharply pointed metal tip, external spark, or other method.

The example of cooking chamber 100 shows components of the cooking chamber. In some embodiments, a commercial plasma cooking chamber will be packaged to appear similar to a conventional microwave oven where cover 107 is a swing door, exhaust lines 109 are more hidden, and gas lines 108, if present at all, are likewise hidden in the packaging.

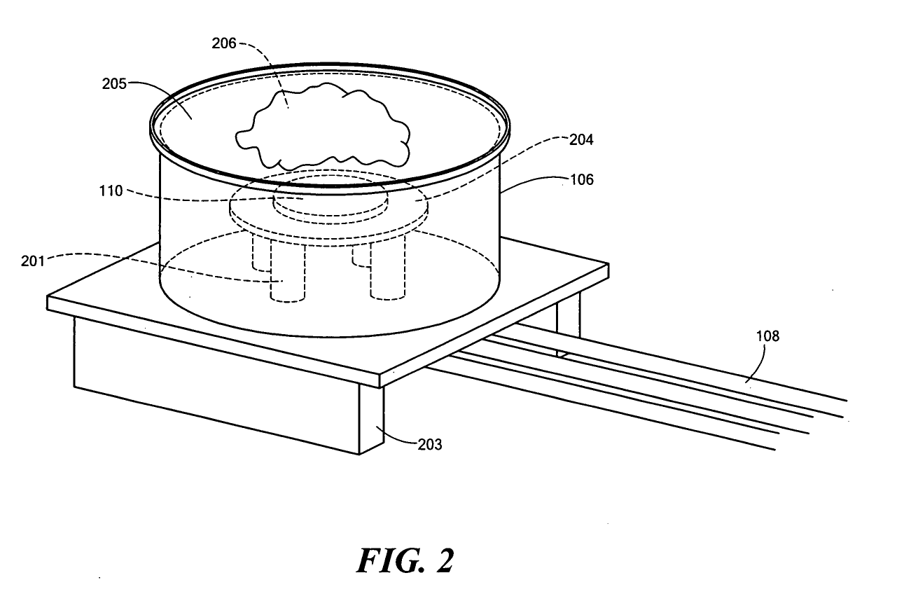

FIG. 2 illustrates a cavity 106 in the microwave chamber for cooking a food item 110 using a plasma immersion method. In some embodiments, cavity 106 can be a cylindrical ceramic/quartz cavity. Food item 110 can be supported on support 204 and positioned by pedestals 201 so that food item 110 is positioned in cavity 106. In some embodiments, food item 110 may be supported by the bottom of cavity 106. A cover 205 can be placed over cavity 204 to form an enclosure around food item 110.

In some embodiments, support 204 can be a flat quartz plate. In some embodiments, support 204 can be formed of quartz, ceramic, or metallic rods arranged so that fat and water that is removed from food item 110 can be drained from cavity 106. In that fashion, food item 110 can be cooked similarly to being placed on a standard BBQ grill. During cooking of meat items, such as for example hamburgers, steaks, chicken, seikh kabab, vegetables, tofu, seafood, or other items, molten fat and water can fall away from food item 110. In some embodiments, support 204 can be biased with a DC or RF voltage in order to help control a plasma formed in cavity 106.

In some embodiments, cavity 106 can be about 2 inches larger than food item 110 and support 204. Further, the height of support 204 from base 203 can be arranged so that food item 110 is positioned about 1 or 2 inches below the top edge of cavity 106. In some cases, a plasma 206 created in cavity 106 has a tendency to be positioned near the top of cavity 106 (i.e., away from base 203).

In some embodiments, base 203 can include a container for collection of fat and water (not shown). The container can, in some embodiments, be metallic or shielded ceramic or shielded quartz in order to prevent the collected fat and water from absorbing microwave power.

Base 203 can also be coupled to gas lines 108. Gas lines 108 can be metallic or non-metallic. Base 203 can be designed to distribute the gas provided through gas lines 108 into cavity 106.

In generating a plasma, a plasma catalyst such as, for example, carbon filings, metallic filings or other powder or elongated conducting entity capable of creating a plasma, is placed on base 203. The powder can then be suspended in cavity 106 by the flow of gas through gas lines 108. As explained in U.S. application Ser. No. 10/430,426, a plasma is created when a gas in cavity 106 is subjected to microwave energy. In some embodiments, any spark producing device can be utilized to ignite the plasma, for example a sharply pointed object or a device similar to a spark plug.

In some embodiments, a catalyst can be sealed into a quartz, ceramic, or other non-conducting enclosure such as a small tube to prevent contamination of the food item with the catalyst. In that fashion, the plasma can be ignited by sparks from the enclosure or by gas that is allowed into the enclosure by passages small enough to prevent the catalyst from leaving.

In some embodiments, 2-3 kW of microwave power may be applied to cooking chamber 100 in order to ignite a plasma in chamber 106. After a plasma has been ignited, the microwave power may be reduced to sustain the plasma at an appropriate level to cook food item 110. However, varying amounts of microwave power up to about 6 to 8 kW of microwave power may be utilized during the process. In some embodiments, cooking chamber 100 may be equipped with multiple microwave radiation sources as is discussed in U.S. application Ser. No. 10/430,415, “Plasma Generation and Processing with Multiple Radiation Sources,” Devendra Kumar et al., filed May 7, 2003, which is herein incorporated by reference in its entirety.

A process for cooking food item 110 in cooking chamber 100 can be as follows:
1. Set up cavity 106 on platform 203;
2. Place food item 110 on support 204 in cavity 106 and position food item 110 appropriately (optionally an aroma or flavor producing material can be added to food item 110);
3. Place a plasma catalyst at a suitable location within the cavity, which may be slightly away from base plate 203 if base plate 203 is metallic;
4. Place cover 205 over cavity 106 to form an enclosed volume around food item 110;
5. Seal cooking chamber 100 by closing cover 107;
6. Flow a gas such as argon gas for a few (e.g., 5-10) seconds to displace any air that is inside cavity, then reduce the flow of gas;
7. Optionally add aroma or flavor producing material to the gas flow;
8. Apply microwave power to generate plasma 206 in cavity 106;
9. Reduce microwave power to suitable levels and cook food item 110 for an appropriate time;
10. Turn power off when food item 110 is properly cooked (as judged by its visual appearance or by a thermocouple or other temperature sensing device—e.g., optical pyrometer);
11. Stop the flow of gas in gas lines 108; and
12. Open cooking chamber 100 to remove cooked food item 110.

In some embodiments, a 1.6 oz hamburger (standard 1/10 pound weight) can be cooked in about 22-23 seconds with about 4-5 kW of microwave power. Actual cooking time can vary depending upon the water and fat content in the meat. In some embodiments, to facilitate starting of the microwave cooking plasma at lower microwave power levels, food item 110 can be initially shielded with a metallic screen or similar device that is removed once the plasma is ignited.

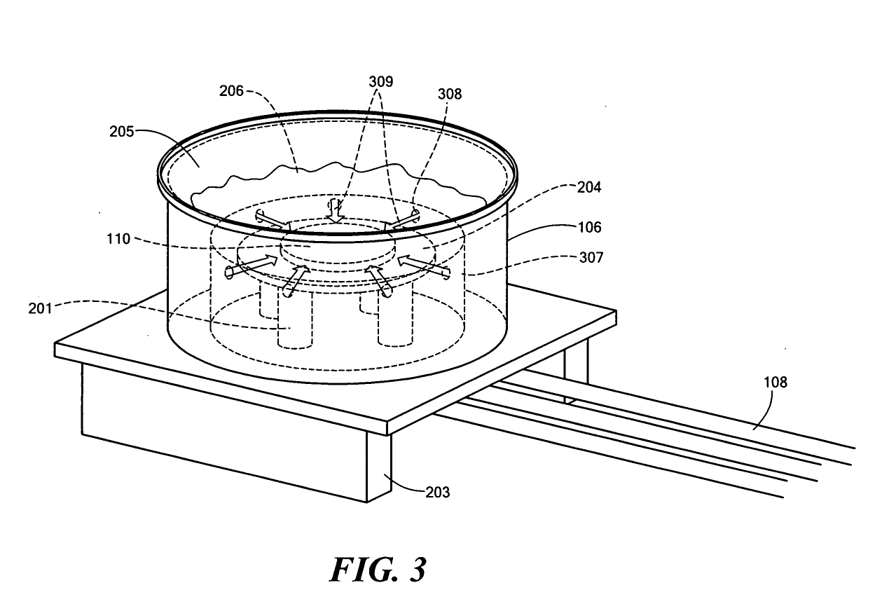

In some embodiments, a plasma jet method may be employed in cooking chamber 100. FIG. 3 illustrates a microwave cavity arrangement that provides a plasma jet method for cooking food. In a plasma jet method, food item 110 is separated from a plasma region in cavity 106, for example with a tube 307. Holes 308 can be placed in tube 307 so that plasma jets 309 from plasma 206 flowing through holes 308 can be directed at food item 110. In some embodiments, a cylindrical tube can be arranged concentrically with cavity 204 so that food item 110 is inside the cylindrical tube while the plasma is generated outside the concentric tube. Plasma jet 309 can be formed through holes 308 formed in the cylindrical tube 307. Cylindrical tube 307 can be metallic or an insulator such as quartz or ceramic.

In an example, a 14-16 gram chicken breast was supported on a horizontal quartz tube inside a 1.5 inch diameter steel tube with holes through which plasma jets were forced to cook the meat. In an exposure of 20 to 30 seconds at a microwave power of about 2-3 kW of microwave power, the chicken was not fully cooked, but experienced some browning. In this arrangement, the chicken was substantially shielded from direct exposure to microwave power by the metallic tube.

If tube 307 is a quartz tube with holes and the chicken is supported on a horizontal quartz plate 204 about 2 inches above base plate 203, the chicken is cooked with a plasma jet as well as with direct microwaves resulting in fully cooked chicken with moderate browning from an exposure of 20-30 seconds to microwave power of 2-3 kW.

Removing tube 307 completely and utilizing the arrangement illustrated in FIGS. 1 and 2 without separating food item 110 from the generated plasma, the full immersion method, provided good results. A 20-30 second exposure of a 14-16 gram chicken breast with microwave power of 2-3 kW resulted in fully cooked chicken with more browning with some black spots. A trial 16 gram hamburger utilizing this method was fully cooked (and continued cooking for a few seconds on support 204), was fully browned, and tasted like a grilled hamburger from a propane BBQ grill.

A 1.6 oz hamburger, was fully cooked and very well browned with good texture and great flavoring when exposed for 23.5 seconds at a 4-5 kW microwave power. A larger base plate 203 may be utilized while cooking larger amounts of meat so as to hold larger amounts of fat and water that is released during cooking.

In another trial, a 1.6 oz hamburger immersed in plasma 206 for about 1.5 seconds squelched the plasma due to coupling of the burger (or the water and fat in the burger) to the microwave energy. A total run time of about 12 seconds resulted in a fully cooked hamburger with no browning from being cooked by microwave exposure alone. The appearance of such a burger was not very appealing.

Subsequently, four runs of 1.6 oz. hamburgers were made with the full plasma immersion method with 6 kW of microwave power for 18.4 sec., 22.0 sec., 22.4 sec, and 24 sec., respectively, with excellent results. Generally, the resulting cooked hamburgers had very good smell, texture, light to moderate browning, and were non-spongy. In one case, the plasma was extinguished after a few seconds only and the hamburger was mostly cooked with microwaves resulting in less than ideal results.

Additionally, two runs where 2.0 oz. chicken breasts were cooked at 6 kW of microwave power for 15 sec. and 13 sec., respectively, had excellent results. Generally, the resulting fully cooked chicken was lightly browned on the surface and had very good texture and smell.

In additional testing with about 1 inch thick pieces of meat showed that a 1 to 1.6 oz. piece of meat can be cooked reasonably well in 15 to 30 seconds with 3-5 kW of microwave power depending upon the desired degree of cooking (e.g., rare, medium, etc.).

Simple modifications to cooking chamber 100 can result in cooking times and power levels that are different from those examples specifically discussed herein. Further, it is believed that cooking in the absence of air (e.g., with an argon or nitrogen flow) may lead to healthier cooked food. Further, modification to cooking chamber 100 can result in the creation of new textures (e.g., meat crispy on the outside and rare on the inside). Further, there is an ability to inject different flavors to the meat during cooking by addition of flavorings into the gas flow.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A cooking apparatus, comprising:
a microwave cavity surrounding a food item; and
a microwave source coupled to the microwave cavity,
wherein a microwave plasma is generated in the microwave cavity to cook the food item placed.

2. The apparatus of claim 1, further comprising gas lines coupled to supply a gas flow into the microwave cavity.

3. The apparatus of claim 1, further comprising a tube placed in the microwave cavity where the food item is separated from the microwave plasma generated in the microwave cavity, the tube including holes through which plasma jets are formed.

4. The apparatus of claim 1, wherein the microwave source includes a plurality of individual sources.

5. The apparatus of claim 1, wherein the microwave cavity includes a support on which a food item is placed and cooked.

6. The apparatus of claim 5, wherein the support is formed from a member of the group consisting of quartz, ceramic, and metal rods.

7. The apparatus of claim 5, wherein the support is mounted on a base, the base capturing fat and water from the food item.

8. A method of cooking a food item, comprising:
placing the food item in a microwave cavity;
flowing gas through the microwave cavity;
applying microwave power to the microwave cavity to ignite a plasma; and
cooking the food item using the plasma.

9. The method of claim 8, further comprising placing the microwave cavity into a chamber and wherein applying microwave power to the microwave cavity includes coupling microwave power into the chamber.

10. The method of claim 8, further comprising adding a flavoring or aroma agent to the gas.

11. The method of claim 8, further comprising capturing fat and water from the food item during cooking.

12. The method of claim 8, wherein placing the food item in a microwave cavity includes placing the food item on a support mounted in the microwave cavity.

13. The method of claim 8, further comprising placing a tube in the microwave cavity where the food item is separated from the plasma generated in the microwave cavity, the tube including holes through which plasma jets are formed.
